(19) United States
(12) Patent Application Publication
(10) Pub. No.: US 2010/0246099 A1
(43) Pub. Date: Sep. 30, 2010

(54) ELECTROLYTIC CAPACITOR AND METHOD OF MAKING THE SAME

(75) Inventors: Kentaro Naka, Kyoto-shi (JP); Takahiro Maeda, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/725,854

(22) Filed: Mar. 17, 2010

(30) Foreign Application Priority Data
Mar. 25, 2009 (JP) 2009-73455
Mar. 2, 2010 (JP) 2010-44856

(51) Int. Cl. H01G 9/14; B23K 31/02; B32B 38/04

(52) U.S. Cl. 361/534; 228/179.1; 228/141.1; 156/250

(57) ABSTRACT

A solid electrolytic capacitor includes a capacitor element, an external conduction member and a fuse conductor. The capacitor element includes a porous sintered body made of valve metal, an anode wire projecting from the porous sintered body, and a dielectric layer and a solid electrolyte layer covering the porous sintered body. The fuse conductor electrically connects the external conduction member and one of the anode wire and the solid electrolyte layer to each other. The fuse conductor is made of a metal containing one of Au—Su-based alloy, Zn—Al-based alloy, Sn—Ag—Cu-based alloy, Sn—Cu—Ni—based alloy and Sn—Sb—based alloy.

### BACKGROUND OF THE INVENTION

1. Field of the Invention

The present invention relates to a solid electrolytic capacitor including a porous sintered body made of e.g. tantalum or niobium. The invention further relates to a method of making a solid electrolytic capacitor.

2. Description of the Related Art

FIG. 26 illustrates an example of conventional solid electrolytic capacitor (see JP-A-2003-142350). The solid electrolytic capacitor X illustrated in the figure includes a capacitor element 91, external connection terminals 92, 93 and a resin package 94 sealing the capacitor element 91. The capacitor element 91 is provided by e.g. a porous sintered body 90. From the inside of the porous sintered body, an anode wire 95 projects. The external connection electrodes 92 and 93 are partially embedded in the resin package 94, with other part extending out of the resin package 94. The external connection electrode 92 is connected to the anode wire 95, whereas the external connection electrode 93 is electrically connected, by a wire 97, to an internal electrode 96 formed on the surface of the capacitor element 91.

In the solid electrolytic capacitor X, the wire 97 functions as a safety fuse, (which is hereinafter simply referred to as “fuse”). Specifically, when an excessive current flows to the solid electrolytic capacitor X Or the temperature of the capacitor element 91 rises abnormally, the wire 97 melts off. This suppresses the malfunction of an electric circuit including the solid electrolytic capacitor X or the overheat of the solid electrolytic capacitor X.

To make the wire 97 properly function as a fuse, the breakage temperature of the wire 97 needs to be set properly. Specifically, the breakage temperature needs to be set, with the ignition temperature of the capacitor element 91, the mounting temperature in mounting the solid electrolytic capacitor X on a circuit board, and so on taken into consideration. For Instance, when the capacitor element 91 is made of tantalum having an ignition temperature of about 400° C. and the solid electrolytic capacitor X is to be mounted on a circuit board by using a solder having a melting point of about 260° C., a wire 97 which melts off at about 300° C. is used.

Au is an example of material for the wire 97 which satisfies the above-described melting condition. However, in order for the wire 97 made of Au to satisfy the above-described melting condition, the wire diameter needs to be extremely small 2 C to 100 μm). Since such an extremely thin wire 97 has low strength, the wire 97 has often been separated from the external connection electrode 93 in molding the resin package 94 in the manufacturing process or broken in transporting the product.

### SUMMARY OF THE INVENTION

The present invention has been proposed under the circumstances described above. It is therefore an object of the present invention to provide a solid electrolytic capacitor which satisfies a desired melting condition and has a proper strength. Another object of the present invention is to provide a method of making such a solid electrolytic capacitor.

According to a first aspect of the present invention, there is provided a solid electrolytic capacitor comprising: a capacitor element including a porous sintered body made of valve metal, an anode wire projecting from the porous sintered body, a dielectric layer covering the porous sintered body, and a solid electrolyte layer; an external conduction member; and a fuse conductor electrically connecting the external conduct ion member and one of the anode wire and the solid electrolyte layer to each other. The fuse conductor is made of a metal containing one of Au—Su-based alloy, Zn—Al-based alloy, Sn—Ag—Cu-based alloy, Sn—Cu—Ni-based alloy and Sn—Sb-based alloy.

Preferably, the fuse conductor is a wire having a diameter of 20 to 100 μm.

Preferably, the fuse conductor includes a bonding portion bonded to one of the anode wire, the solid electrolyte layer and the external conduction member, and the bonding portion has a diameter of 200 to 300 μm.

Preferably, the bonding portion has a height of 30 to 70 μm.

Preferably, the fuse conductor is made of Au—Sn-based alloy, and weight % of Sn lies in one of a range of 5 to 35 and a range of 55 to 75.

Preferably, the solid electrolytic capacitor according to the first aspect further includes a resin package covering the capacitor element. The external conduct ion member includes a thin plate portion, a flat plate portion and a connecting portion. The thin plate port ton includes a mount terminal portion exposed from the resin package. The flat plate portion is covered with the resin package and bonded to the fuse conductor. The connecting portion connects the thin plate portion and the fiat plate Portion to each other.

Preferably, the thin plate portion and the flat plate portion are parallel with each other.

Preferably, the connecting portion is bent and smaller than the flat plate portion in cross section when cut in a plane that is perpendicular to a direction in which the flat plate portion and the thin plate portion are connected to each other.

Preferably, the connecting portion is covered with the resin package. Alternatively, part of the connecting portion may be exposed from the resin package.

Preferably, the thin plate portion includes a thin wall portion and a thick wall portion. As viewed in the thickness direction of the thin plate portion, the thin wall portion overlaps the capacitor element, whereas the thick wall portion does not overlap the capacitor element.

Preferably, the solid electrolytic capacitor according to the first aspect further includes a resin package Covering the capacitor element. The external conduction member includes a thin plate portion and a standing portion that is perpendicular to the thin plate portion. The thin plate portion includes a mount terminal portion exposed from the resin package. The fuse conductor includes an end bonded to the standing portion.

Preferably, the thin plate portion includes a thin wall portion and a thick wall portion. As viewed in the thickness direction of the thin plate portion, the thin wall portion overlaps the capacitor element, whereas the thick wall portion does not overlap the capacitor element.

Preferably, the solid electrolytic capacitor according to the first aspect further includes a resin package covering the capacitor element. The external conduction member is electrically connected to the anode wire. Part of a surface of the external conduction member and part of a surface of the resin package are connected to be flush with each other to form an end surface. The direction in which the anode wire extends crosses the end surface.

Preferably, the anode wire and the external conduction member are electrically connected to each other by the fuse conductor.

Preferably, the external conduction member includes a thin plate portion including a mount terminal portion exposed from the resin package. The thin plate portion includes a thin wall portion and a thick wall portion. As viewed in the thickness direction of the thin plate portion, the thin wall portion overlaps the capacitor element, whereas the thick wall portion does not over the capacitor element.

Preferably, the fuse conductor is in the form of a strip or sphere.

Preferably, the porous sintered body is made of one of tantalum and niobium.

According to a second aspect of the present invention, there is provided a solid electrolyte capacitor including: a capacitor element including a porous sintered body made of valve metal, an anode wire projecting from the porous sintered body, and a dielectric layer and a solid electrolyte layer covering the porous sintered body; an external conduction member; a fuse conductor electrically connecting the external conduction member and one of the anode wire and the solid electrolyte layer to each other; and a board. The board includes a plate-like insulating substrate, an anode pattern, and an intermediate pattern spaced away from the anode pattern, where both patterns are formed on an obverse surface of the insulating substrate. The board further includes an anode electrode pattern formed on a reverse surface of the insulating substrate, and an anode via hole connecting the intermediate pattern and the anode electrode pattern to each other. The anode wire is bonded to the anode pattern, and the anode pattern and the intermediate pattern are connected to each otter by the fuse conductor.

Preferably, the anode wire is arranged adjacent to the insulating substrate in the thickness direction of the capacitor element.

Preferably, the board is provided with a cathode-pattern formed on the obverse surface of the insulating substrate, a cathode electrode pattern formed on the reverse surface of the insulating substrate, and a cathode via hole connecting the cathode pattern and the cathode electrode pattern to each other. The cathode pattern is electrically connected to the solid electrolyte layer.

Preferably, the fuse conductor is made of a metal containing one of Au—Su-based alloy, Zn—Al-based alloy, Sn—Ag—Cu-based alloy, Sn—Cu—Ni-based alloy and Sn—Sb-based alloy.

Preferably, the porous sintered body is made of one of tantalum and niobium.

According to a third aspect of the present invention, there is provided a method of making a solid electrolytic capacitor. This method is a manufacturing method of a solid electrolytic capacitor including a capacitor element including a porous sintered body made of valve metal, an anode wire projecting from the porous sintered body, and a dielectric layer and a solid electrolyte layer covering the porous sintered body. The method includes the steps of bonding a first end of a fuse conductor to an external conduction member by ball bonding and electrically connecting a second end of the fuse conductor to one of the anode wire and the solid electrolyte layer.

Preferably, the method further includes the steps of erecting the fuse conductor after bonding the first end of the fuse conductor to the external conduction member, bending the external conduction member, with the fuse conductor bonded thereto, and bonding the second end of the fuse conductor to the conductor layer, with the external conduction member bent.

Preferably, the fuse conductor is made of a metal containing one of Al—Su-based alloy, Zn—Al-based alloy, Sn—Ag—Cu-based alloy, Sn—Cu—Ni-based alloy and Sn—Sb-based alloy.

According to a fourth aspect of the present invention, there is provided, a method of making a solid electrolytic capacitor. This method is a manufacturing method of a solid electrolytic capacitor including a capacitor element including a porous sintered body made of valve metal, an anode wire projecting from the porous sintered body, and a dielectric layer and a solid electrolyte layer covering the porous sintered body. The method includes the steps of bonding a first and of a fuse conductor to an external conduction member, electrically connecting a second end of the fuse conductor to one of the anode wire and the solid electrolyte layer, forming a resin package to cover the capacitor element, and collectively cutting the resin package and the external conduction member.

Preferably, the fuse conductor is made of a metal containing one of Au—Su-based alloy, Zn—Al-based alloy, Sn—Ag—Cu-based alloy, Sn—Cu—Ni-based alloy and Sn—Sb-based alloy.

Other features and advantages of the present invention will become more apparent from the detailed description given below with reference to the accompanying drawings.

### BRIEF DESCRIPTION OF THE DRAWINGS

FIG. 1 is a perspective view illustrating a solid electrolytic capacitor according to a first embodiment of the present invention;

FIG. 2 is a sectional view taken along lines II-II in FIG. 1;

FIG. 3 is an enlarged sectional view illustrating a first bonding portion or a fuse wire;

FIG. 4 is a graph illustrating the relationship between the diameter of the first bonding portion and bonding strength;

FIG. 5 is a graph illustrating the relationship between the diameter of the first bonding portion and frequency of occurrence of defects;

FIG. 6 is a graph illustrating the relationship between the height of the first bonding portion and frequency of occurrence of defects;

FIG. 7 is a sectional view illustrating a solid electrolytic capacitor according to a second embodiment of the present invention;

FIG. 8 is a perspective view illustrating a step of a method for manufacturing the solid electrolytic capacitor according to the second embodiment;

FIG. 9 is a perspective view illustrating another step of the manufacturing method;

FIG. 10 is a perspective view illustrating a variation of the solid electrolytic capacitor according to the first embodiment of the present invention;

FIG. 11 is a perspective view illustrating a solid electrolytic capacitor according to a third embodiment of the present invention;

FIG. 12 is a sectional view taken along lines XII-XII in FIG. 11;

FIG. 13 is a plan view illustrating a step of a method for manufacturing the solid electrolytic capacitor according to the third embodiment of the present invention;

FIG. 14 is a sectional view illustrating a solid electrolytic capacitor according to a fourth embodiment of the present invention;

FIG. 15 is a sectional view illustrating a step of a method for manufacturing the solid electrolytic capacitor according to the fourth embodiment;

FIG. 16 is a sectional view illustrating a solid electrolytic capacitor according to a fifth embodiment of the present invention;

FIG. 17 is a perspective view illustrating a solid electrolytic capacitor according to the fifth embodiment of the present invention;

FIG. 18 is a sectional view illustrating a step of a method for manufacturing the solid electrolytic capacitor according to the fifth embodiment;

FIG. 19 is a sectional view illustrating a solid electrolytic capacitor according to a sixth embodiment of the present invention;

FIG. 20 is a perspective view illustrating a solid electrolytic capacitor according to a seventh embodiment of the present invention;

FIG. 21 is a perspective view illustrating a solid electrolytic capacitor according to an eighth embodiment of the present invention;

FIG. 22 is a sectional view illustrating a solid electrolytic Capacitor accordion to a ninth embodiment of the present invention;

FIG. 23 is a sectional view illustrating a solid electrolytic capacitor according to a tenth embodiment of the present invention;

FIG. 24 is a perspective view illustrating a solid electrolytic capacitor according to an eleventh embodiment of the present invention;

FIG. 25 is a perspective view illustrating a solid electrolytic capacitor according to a twelfth embodiment of the present invention; and

FIG. 26 is a sectional, view illustrating an example of conventional solid electrolytic capacitor.

### DETAILED DESCRIPTION OF THE PREFERRED EMBODIMENTS

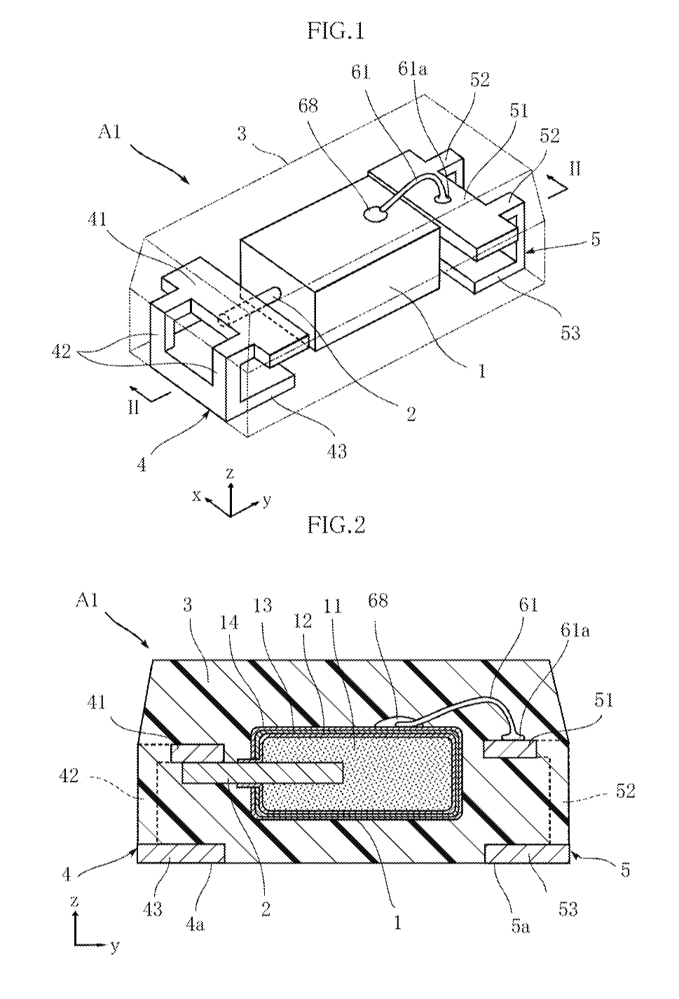

FIGS. 1 and 2 illustrate a solid electrolytic capacitor according to a first embodiment of the present invention. The solid electrolytic capacitor A1 of this embodiment includes a capacitor element 1, an anode wire 2, a resin package 3, an anode conduction member 4, a cathode conduction member 5 and a fuse wire 61. The solid electrolytic capacitor A1 may be used to remove noise in an electric circuit or supplement power supply. In FIG. 1, the resin package 3 is illustrated with double-dashed lines. The overall dimensions of the solid electrolytic capacitor A1 are e.g. 2.0 mm in length, 1.25 mm in width and 1.1 mm in height.

The capacitor element 1 is made up of a porous sintered body 11, a dielectric layer 12, a solid electrolyte layer 13 and a conductor layer 14. The porous sintered body 11 is made of a valve metal such as tantalum or niobium and includes many pores formed therein. The porous sintered body 11 is made by compression-molding powder of a valve metal and then sintering the molded body. In the sintering process, powder particles of the valve metal sinter Together to provide the porous sintered body 11 including many pores.

The dielectric layer 12 is provided on the surface of the porous sintered body 11 and made of an oxide of a valve metal. The dielectric layer 12 is formed by e.g. performing anodic oxidation, with the porous sintered body 11 immersed in a chemical conversion liquid of phosphoric acid aqueous solution.

The solid electrolyte layer 13 is laminated to cover the surface of the dielectric layer 12 and fill the pores of the porous sintered body 11. The solid electrolyte layer 13 is made of e.g. manganese dioxide or a conductive polymer. In the solid electrolytic capacitor A1, electric charge builds up at the interface between the solid electrolyte layer 13 and the dielectric layer 12.

The conductor layer 14 has a laminated structure made up of e.g. a graphite layer and an Ag layer and is formed to cover the solid electrolyte layer 13.

The anode wire 2 is made of a valve metal such as tantalum or niobium similarly to the porous sintered body 11, and projects from the inside of the porous sintered body 11 in the longitudinal direction (y direction in FIG. 1). The above-described pressure-molding of the valve metal powder is performed, with part of the anode wire 2 embedded in the powder. By such pressure-molding, the porous sintered body 11 made integral with the anode wire 2 is obtained.

The resin package 3 is made of e.g. an epoxy resin and protects the porous sintered body 11. The resin package 3 is made by molding using e.g. an epoxy resin material.

The anode conduction member 4 is made of e.g. Cu-plated Ni—Fe alloy (such as 42 alloy) and made up of a flat plate portion 41, a connecting portion 42 and a thin plate portion 43. As illustrated in FIG. 1, the flat plate portion 41 is in the form of a flat plate elongated in the x direction (i.e., the dimension in the x direction is larger than that in the y direction). To the flat plate portion 41, the anode wire 2 is bonded. The connecting portion 42 is made up of a pair of strip-shaped elements extending from an end surface (rectangular surface elongated in the x direction) of the flat plate portion 41 in parallel with each other. Each of the strip-shaped elements is bent substantially at right angles, and the lower end of the strip-shaped element is connected to part of the upper surface of the thin plate portion 43. More specifically, each of the strip-shaped elements includes a horizontal portion extending from the flat plate portion 41 and a vertical portion extending between the horizontal portion and the thin plate portion 43. The cross sectional area of the horizontal, portion (the area when cut along an x-y plane in FIG. 1) is equal to the cross sectional area of the vertical portion (the area when cut along the x-y plane in FIG. 1), but smaller than the cross sectional area of the flat plate portion 41 (=the area of the above-described elongated rectangular surface). In other words, when cut along a plane perpendicular to the connecting direction of the flat plate portion 41 and the thin plate portion 43, the cross sectional area of each strip-shaped element (connecting portion 42) is smaller than that of the flat plate portion 41. The thin plate portion 43 is in the form of a flat plate and arranged in parallel with the flat plate portion 41. The reverse surface of the thin plate portion 43 is exposed from the resin package 3 (see 2). The exposed surface of the thin plate portion 43 is used as an anode mount terminal 4a in surface-mounting the solid electrolytic capacitor A1 on e.g. a circuit board.

Similarly to the anode conduction member 4, the cathode conduction member 5 is made of e.g. Cu-plated Ni—Fe alloy (such as 42 alloy) and made up of a flat plate portion 51, a connecting portion 52 and a ti plate portion 53. The flat plate portion 51 is in the form of a flat plate elongated in the x direction. To the flat plate portion 51, the fuse wire 61 is bonded. The connecting portion 52 is up of a pair of strip-shaped elements extending; parallel with each other from an end surface of the flat plate portion 51 which is elongated in the x direction. With this arrangement, the cross sectional area of the connecting portion 52 (each strip-shaped element) is smaller than that of the flat plate portion 51 (=the area of the above-described end, surface). The connecting portion 52 is bent substantially at right angles, and the lower end of the connecting portion 52 is connected to the thin plate portion 53. The thin plate portion 53 is in the form of a flat plate and arranged in parallel with the flat plate portion 51. The reverse surface of the thin plate portion 53 is exposed from the resin package 3. The exposed surface of the thin plate portion 53 is used as a cathode mount terminal 5a in surface-mounting the solid electrolytic capacitor A1 on e.g. a circuit board.

The fuse wire 61 connects the conductor layer 14 of the capacitor element 1 and the cathode conduction member 5 to each other. The fuse wire 97 has a function as a fuse which melts off to interrupt current flow to the solid electrolytic capacitor A1 when an excessive current flows to the solid electrolytic capacitor A1 or the capacitor element 1 is excessively heated up. In this embodiment, the fuse wire 61 is made of an Au—Sn-based alloy and has a diameter of e.g. 20 to 100 μm. The amount of Sn contained in the Au—Sn-based alloy is e.g. 1 to 90 weight % (preferably 5 to 33 weight % or 55 to 75 weight %) (when the total weight of Au and Sn is 100). Alternatively, the fuse wire 61 may be made of Au, with its surface plated with Sn.

One end of the fuse wire 61 is bonded to the flat plate portion 51 of the cathode conduction member 5. As the bonding method, what is called ball bonding is employed. Specifically, ball bonding is performed in e.g. N₂—H₂ gas atmosphere. An Au—Sn-based alloy wire held by a heated capillary is sparked, thereby making an end of the wire into a ball. Then, the ball-shaped portion is bonded to the flat Plate portion 51 of the cathode conduction member 5 by thermocompression. The portion bonded by thermocompression is called a first bonding portion (reference sign 61a).

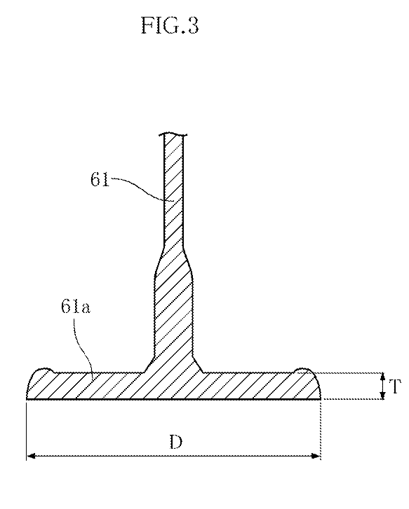

As illustrated in FIG. 3, the first bonding portion 61a is a portion pressed into a flat shape and substantially in the form of a disc with a slightly bulging periphery. In this embodiment, the diameter D of the portion where the first bonding portion 61a is bonded to the flat plate portion 51 is 200 to 300 μm. The height T of the flat portion of the first bonding portion 61a is 30 to 70 μm. As illustrated in FIGS. 1 and 2, the other end of the fuse wire 61 is bonded to the conductor layer 14 of the capacitor element 2 by a bonding portion 68 made of e.g. Ag paste.

The advantages of the solid electrolytic capacitor A1 are described below.

As noted before, by making the fuse wire 61 out of an Au—Sn-based alloy, the fuse wire has a higher strength than a fuse wire made of e.g. Au. Consequently, even when the fuse wire 61 is made to have an extremely small wire diameter of e.g. about 20 to 100 μm, the fuse wire 61 is neither easily separated from the cathode conduction member 5 in molding the resin package 3 nor cut in transporting the product. Further, by making the fuse wire 61 cut of an Au—Sn-based alloy, the use of lead, which is harmful to the human body and the environment, is eliminated.

The use of an extremely thin fuse wire 61 having a diameter of e.g. 20 to 100 μm as described above enables easy dragging of the wire by a capillary in e.g. the ball bonding process. Moreover, the use of such a thin fuse wire is favorable for the size reduction of the solid electrolytic capacitor A1.

Since the fuse wire 61 is made of an Au—Sn-based alloy having the above-described composition, the fuse wire melts at temperature which is lower than the ignition temperature (e.g. 400° C.) of tantalum, which forms the porous sintered body 11, and higher than the mounting temperature (e.g. 240 to 260° C.) in mounting the solid electrolytic capacitor A1 on a circuit board (not shown). Thus, when the temperature in the reflow furnace is e.g. 260° C. or below in mounting on a circuit board, the fuse wire 61 does not melt off. That is, the fuse wire 61 does not unnecessarily melt off at temperature at which the solid electrolytic capacitor A1 can operate normally.

The bonding of one end of the fuse wire 63 and the cathode conduction member 5 is performed by ball bonding. This ensures that the fuse wire 61 is bonded within a narrow area in the surface of the cathode conduction member 5, which is suitable for making a small solid electrolytic capacitor.

Experiments performed to confirm the above-described advantages are described below with reference to Table 1. In the experiments, a plurality of kinds of solid electrolytic capacitors differing from each other in structure of the fuse wire (material, diameter) were prepared, and each of the solid electrolytic capacitors was examined for current breakage time, breakage temperature and the number of wire defects such as wire cut or wire sweep) produced in the manufacturing process.

TABLE 1

| | | | | | Number of |
|---|---|---|---|---|---|
| | | | | | wire |
| | | | | | defects |
| | | Breakage time | | Breakage | [per |
| | Fuse wire | 2A | 5A | temperature | 1,000] |
| (A) | Au φ60 μm | no | 1.5 sec | no breakage | 0 |
| | | breakage | | | |
| (B) | Au φ38 μm | no | 160 msec | no breakage | 5 |
| | | breakage | | | |
| (C) | Au φ20 μm | 200 msec | 40 msec | no breakage | 350 |
| (D) | Au—Sn-based | 350 msec | 60 msec | 340° C. | 0 |
| | alloy (18 wt %) | | | | |
| | φ60 μm | | | | |
| (E) | Pb—Sn—Ag | 1 sec | 80 msec | 330° C. | 0 |
| | φ150 μm | | | | |

As the fuse wires, the following five kinds were prepared. (A): wire made of Au with a diameter of about 60 μm, (B): wire made of Au with a diameter of about 38 μm, (C): wire made of Au with a diameter of about 20 μm, (D): wire made of Au—Sn-based alloy containing about 18 wt. % of Sn, with a diameter of about 60 μm, (E): wire made of Pb—Sn—Ag-based alloy with a diameter of about 150 μm. Herein, the wire of (D) is the wire applied to the fuse wire 61 according to this embodiment.

In the experiment to examine the current breakage time, a current of 2A and a current of 5A were applied to each of toe solid electrolytic capacitors, and the time taken until the fuse wire broke by melting was measured for each current. As a result, when a current of 2A was applied, the wires of (A) and (B) did not melt off, whereas the wires of (C)-(E) melted off in 200 msec to 1 sec. When a current of 5A was applied, the wires of (A)-(E) melted off in 4 C msec to 1.5 sec. Generally, it is believed to be desirable that a fuse wire melts off within 1 sec when a current of e.g. 2 to 5 A is applied. In this regard, the wire of (D) showed a proper breakage time.

In the experiment to examine the breakage temperature, the wire of (D) melted off at 340° C., whereas the wire of (E) melted off at 330° C. The temperature of 340° C., which is the breakage temperature of the wire CD), is a proper breakage temperature which is lower than the ignition temperature of tantalum (about 400° C.) and higher than the mounting temperature (about 240 to 260° C.) of the solid electrolytic capacitor A1.

In the experiment to examine the number of wire defects produced in the manufacturing process, the wires of (B) showed defects (such as wire cut or wire sweep) at a rate of 5 per 1000, whereas the wires of (C) showed defects at a rate of 350 per 1000. The wires of (C) click not show any defects.

In this way, the experiments confirmed that the wire of (D), which is applied to the fuse wire 61 of toe present embodiment, breaks in a proper breakage time. Further, the fuse wire 61 does not break at mounting temperature at which the solid electrolytic capacitor A1 is mounted en a circuit board. The fuse wire 61 does not unnecessarily break at temperature at which the solid electrolytic capacitor A1 can operate normally. Moreover, the experiments confirmed that wire cut, wire sweep and the like do not occur in the manufacturing process.

In addition to toe above-described experiments, experiments were further performed, the results of which are shown in Table 2.

TABLE 2

| | | | | | Number |
|---|---|---|---|---|---|
| | | | | | of |
| | Wire | | | | wire |
| | diam- | Breakage time | | Breakage | defects |
| | eter | [msec] | | temperature | [per |
| Material | [μm] | 2A | 5A | [° C.] | 1,000] |
| Au—Sn-based | φ100 | no | 980 | 320 | 0 |
| | | breakage | | | |
| | φ80 | 1,100 | 180 | 320 | 0 |
| | φ60 | 350 | 60 | 320 | 0 |
| | φ40 | 160 | 20 | 320 | 0 |
| | φ20 | 90 | 18 | 320 | 4 |
| Zn—Al-based | φ100 | no | 150 | no breakage | 0 |
| | | breakage | | | |
| | φ80 | no | 80 | no breakage | 0 |
| | | breakage | | | |
| | φ60 | 200 | 60 | no breakage | 0 |
| Sn—Ag—Cu-based | φ100 | no | 120 | 240 | 0 |
| | | breakage | | | |
| | φ60 | 350 | 60 | 240 | 0 |
| Sn—Cu—Ni-based | φ100 | 600 | 80 | 250 | 0 |
| | φ60 | 300 | 40 | 250 | 0 |
| Sn—Sb-based | φ100 | 200 | 50 | 260 | 0 |
| | φ60 | 150 | 40 | 260 | 1 |

As shown in Table 2, the Au—Sn-based wires properly break by melting at certain current and temperatures. Further, although the wires with a diameter of 20 μm showed a small number of wire defects, wires with larger diameters did not show any wire defects. These facts indicate that Au—Sn-based wires can properly function as a fuse for both of overcurrent prevention and overheat prevention.

The Zn—Al-based wires showed the tendency to break relatively in a short period of time due to overcurrent. This indicates that Zn—Al based wires can suitably function as a fuse for overcurrent prevention.

All of the Sn—Ag—Ca-based wires, Sn—Cu—Ni-based wires and Sn—Sb-based wires showed the tendency to break relatively in a short period of time due to overcurrent. Moreover, these wires broke at relatively low temperatures. That is, the Sn—Ag—Cu-based wires, Sn—Cu—Ni-based wires and Sn—Sb-based wires can suitably function as a fuse for overcurrent prevention and overheat prevention when the temperature to which they are exposed in the manufacturing process is relatively low.

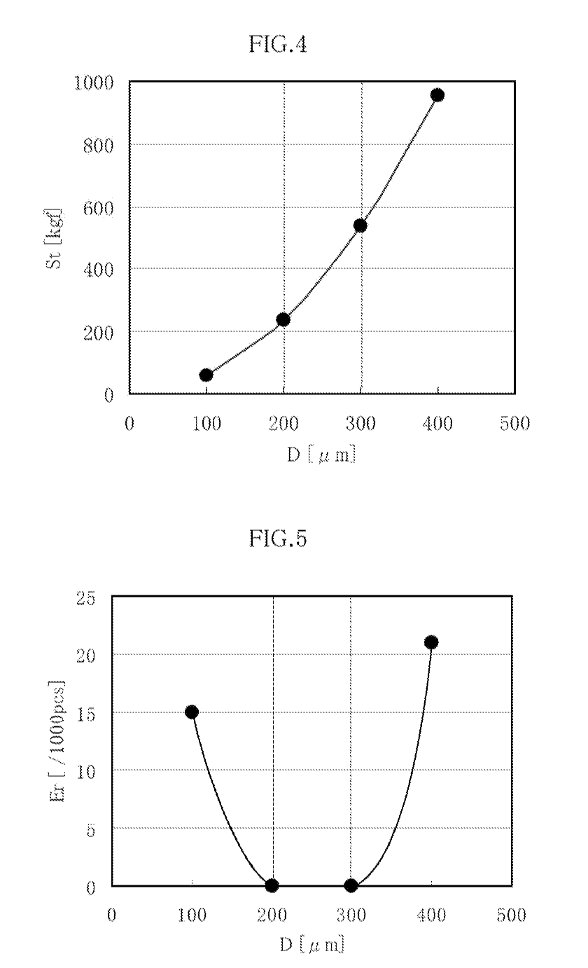

FIG. 4 illustrates the relationship between the diameter of the first bonding portion 61a and the bonding strength St of the first bonding portion 61a. As illustrated in the figure, the bonding strength St increases as the diameter D increases. FIG. 5 illustrates the relationship between the diameter D and the frequency Er of occurrence of defects such as wire cut. When the diameter D is in the range of 200 to 300 μm, the defect occurrence frequency Er is 0. In this range, the bonding strength St is about 200 to 500 kgf, an illustrated in FIG. 4. These facts indicate that, by employing the structure in which the diameter D is set to 200 to 300 μm, proper bonding strength Si is obtained and the defect occurrence frequency Er is reduced.

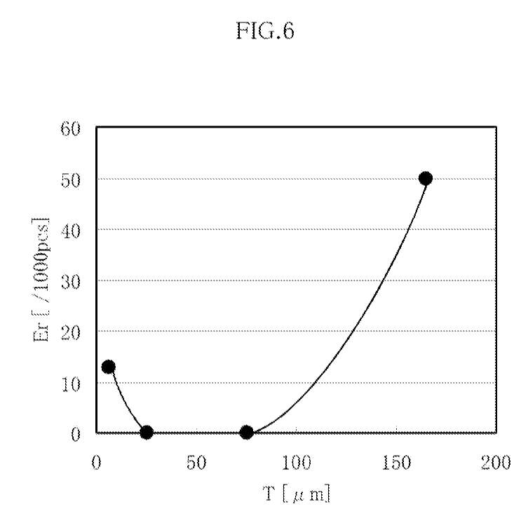

FIG. 6 illustrates the relationship between the height T of the first bonding portion 61a and the defect occurrence frequency Er. As will be understood from the figure, when the height T is in the range of 30 to 70 μm, the defect occurrence frequency Er is 0. This indicates that the defect occurrence frequency Er is suitably reduced by employing the structure in which the height T is set to 30 to 70 μm.

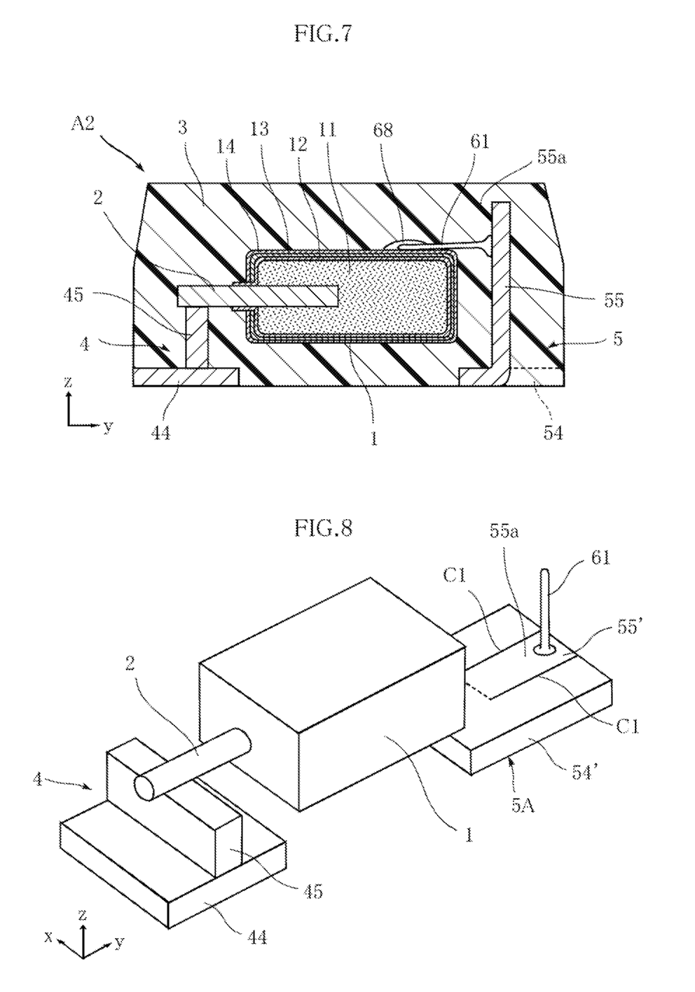

FIGS. 7-25 illustrate other embodiments of solid electrolytic capacitor according to the present invention. In these figures, the elements which are identical or similar to those of the first embodiment are designated by the same reference signs as those used for the first embodiment.

FIG. 7 illustrates a solid electrolytic capacitor according to a second embodiment of the present invention. The solid electrolytic capacitor A2 of this embodiment differs from the solid electrolytic capacitor A1 of the above-described first embodiment in structure of the anode conduction member 4 and the cathode conduction member 5. In this embodiment, the anode conduction member 4 is made up of a thin plate portion 44 and an auxiliary portion 45. The thin plate portion 44 is in the form of a flat plate spreading in the x-y plane. The auxiliary portion 45 is substantially in the form of a rectangular parallelepiped elongated in the x direction. The auxiliary portion 45 serves to support the anode wire 2. To the upper end surface of the auxiliary portion 45, the anode wire 2 is bonded by e.g. resistance welding or laser welding.

The cathode conduction member 5 is made up of a thin plate portion 54 and a standing portion 35. The thin plate portion 54 spreads in the x-y plane. The standing portion 55 is formed by making an elongated plate portion stand from the thin plate portion 54 in the z direction. The thin plate portion 54 after the formation of the standing portion 55 includes a recess corresponding to the elongated plate portion. The standing portion 55 includes a surface 55a extending in parallel with an end surface of the capacitor element 1. To the surface 55a of the standing portion 55, the proximal end of the fuse wire 61, which extends perpendicularly to the surface 53a, is bonded. The distal end of the fuse wire 61 (the end opposite to the proximal end) is bonded to the bonding surface (upper surface in FIG. 7) of the conductor layer 14 of the capacitor element 1.

As illustrated in FIG. 7, the standing portion 55 is arranged close to the bonding surface of the conductor layer 14, and the surface 55a spreads in a direction which is perpendicular to the bonding surface. The fuse wire 61 has a simple bar-like shape extending straight. These features ensure that the fuse wire 61 connects the conductor layer 14 and the surface 55a to each other at a short distance.

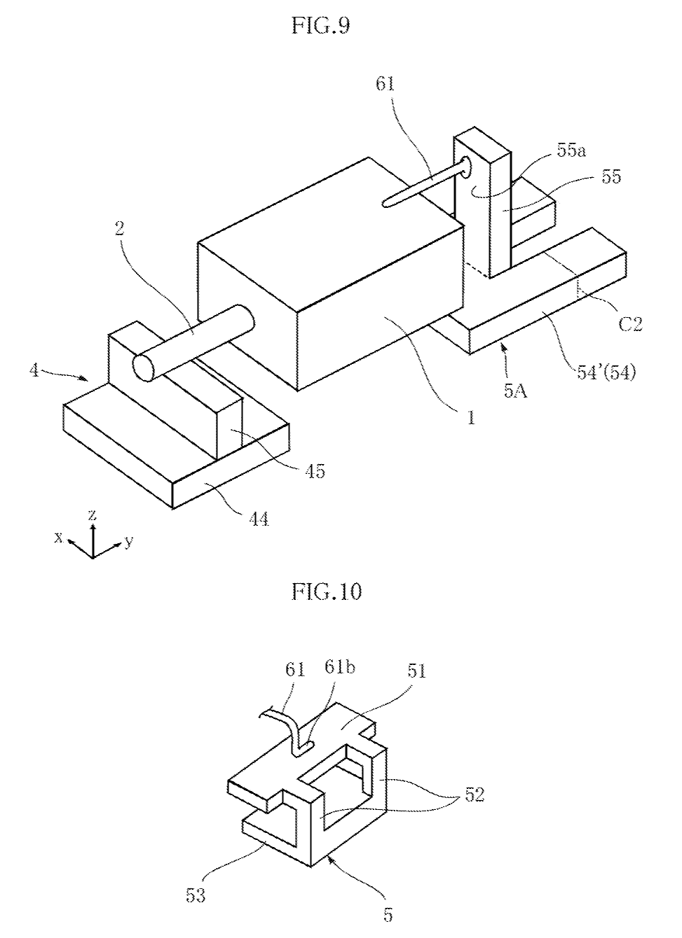

FIGS. 8 and 9 illustrate part of a method for making the solid electrolytic capacitor A2. In particular, these figures illustrate an example of bonding of the capacitor element 1 to the anode conduction member 4 and the cathode conduction member 5. In this manufacturing process, a thin plate portion 44 and an auxiliary portion 45, which are to become portions forming the anode conduction member 4, and a member 5A including portions 54′ and 55′, which are to become the thin plate portion 54 and the standing portion 55 of the cathode conduction member 5, are prepared. The thin plate portion 44, the auxiliary portion 45 and the member 5A are formed by e.g. subjecting a Cu-plated plate made of Ni—Fe alloy such as 42 alloy to punching and press working or etching.

First, the auxiliary portion 45 is placed on the obverse surface of the thin plate portion 44 to extend in the x direction and bonded to the obverse surface. Then, to the upper end surface of the auxiliary portion 45, the anode wire 2 of the capacitor element 1 is bonded by e.g. resistance welding or laser welding. In this process, to stabilize the capacitor element 1, a seat for supporting the capacitor element 1 may be placed under the capacitor element.

Then, two cuts C1 are formed in the portion 54′, which is to become the thin plate portion 54, so as to correspond to the width and length of the standing portion 55. Then, by ball bonding, an end of a fuse wire 61 is bonded to the portion 55′, which is to become the standing portion 55, at a position close to the end. Thereafter, adjustment is performed to make the fuse wire 61 stand normal to the surface 55a of the portion 55′. Alternatively, the fuse wire 61 may be made stand normal to the surface 55a from the moment when the fuse wire 61 is bonded to the portion 55′.

Then, as illustrated in FIG. 9, the root of the portion 55′ is bent until the distal end of the fuse wire 61 comes into contact with the conductor layer 14 of the capacitor element 1. Then, a bonding portion 68 (see FIG. 7) is formed at or near the distal end of the fuse wire 61 by using e.g. Ag paste, whereby the distal end of the fuse wire 61 is bonded to the conductor layer 14. In this case, it is preferable that the bonding portion of the distal end of the fuse wire 61 and the conductor layer 14 is closer to the cathode conduction member 5.

Thereafter, the member 54′ is cut along the cutting line C2 indicated in FIG. 9, whereby a thin plate portion 54 is formed. Then, a resin package 3 is formed to cover the capacitor element 1, whereby the solid electrolytic capacitor A2 illustrated in FIG. 7 is obtained.

With the above-described technique, the structure of the anode conduction member 4 and cathode conduction member 5 is further simplified, which makes it possible to shorten the manufacturing process and reduce the size of the solid electrolytic capacitor A2. Since the fuse wire 61 is in the form of a straight bar, its manufacturing is easier than that of the fuse wire 61 of the first embodiment, and the breakage of the wire itself within a capillary or the like is prevented. The length of the fuse wire 61 can be made relatively short, which leads to a reduction of the material.

Although the bonding of an end of the fuse wire 61 and the cathode conduction member 5 (5A) is performed by ball bonding in the first and the second embodiments, other bonding methods may be employed. For instance, scissors bonding, wedge bonding or spot welding may be employed.

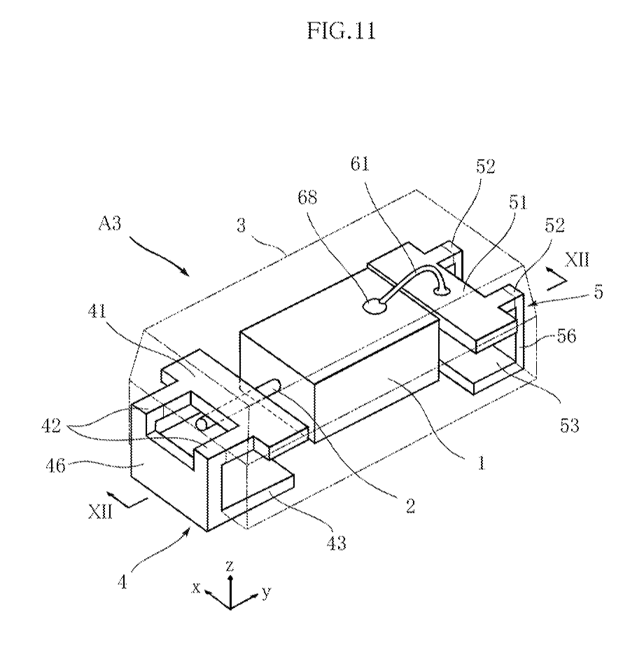

Moreover, as illustrated in e.g. FIG. 10, as a variation of the solid electrolytic capacitor A1, an end of the fuse wire 61 may be bent to extend in the longitudinal direction of the flat plate portion 51 of the cathode conduction member 5, and the bent portion 61b may be bonded to the obverse surface of the flat plate portion 51. With this method again, the fuse wire 61 and the flat plate portion 51 can be connected to each other at a relatively small bonding area.

FIGS. 11 and 12 illustrate a solid electrolytic capacitor according to a third embodiment of the present invention. The solid electrolytic capacitor A3 of this embodiment differs from the foregoing solid electrolytic capacitor A1 in that part of the connecting portion 42 of the anode conduction member 4 and part of the connecting portion 52 of the cathode conduction member 5 project from the resin package 3. The connecting portion 42 and the connecting portion 52 project from the resin package 3 in the y direction, and bend downward to extend in the z direction. The anode conduction member 4 of this embodiment includes a side plate portion 46. The connecting portion 42 is connected to the side plate portion 46. The lower end of the side plate portion 46 is connected to the thin, plate portion 43. The cathode conduction member 5 includes a side plate portion 56. The connecting portion 52 is connected to the side Plate portion 56. The lower end of the side plate portion 56 is connected to the thin plate portion 53.

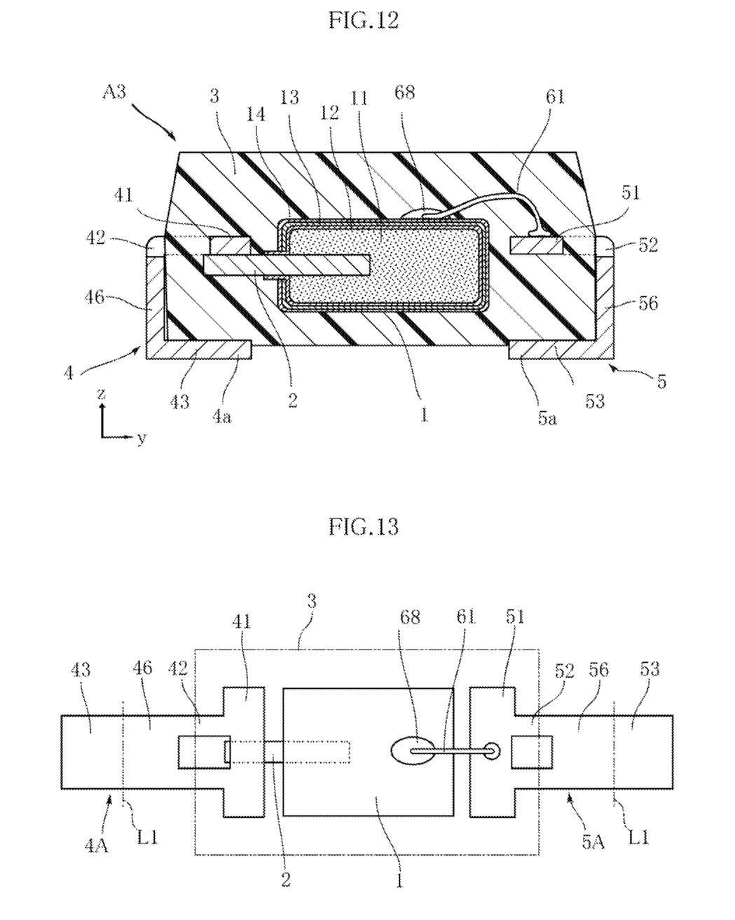

FIG. 13 illustrates a step of an example of method for making the solid electrolytic capacitor A3. Members 4A and 5A formed by e.g. punching a first plate are prepared. The member 4A includes a flat plate portion 41, a connecting portion 42, a side plate portion 46 and a thin plate portion 43. The member 5A includes a flat plate portion 51, a connecting portion 52, a side plate portion 56 and a thin plate portion 53. After performing the bonding of a capacitor element 1 and a wire 61, a resin package 3 is formed. Thereafter, the connecting portions 42 and 52 are bent substantially at right angles, and the members 4A and 5A are further bent along the bend lines L1. By this process, the solid electrolytic capacitor A3 is obtained.

According to this embodiment, a solder fillet can be formed on the side plate portions 46 and 56 exposed from the resin package 3, which contributes to the enhancement of the mounting strength of the solid electrolytic capacitor A3. The work to bend the connecting portions 42 and 52, which have a relatively small cross sectional area, after the formation of the resin package 3 is relatively easy.

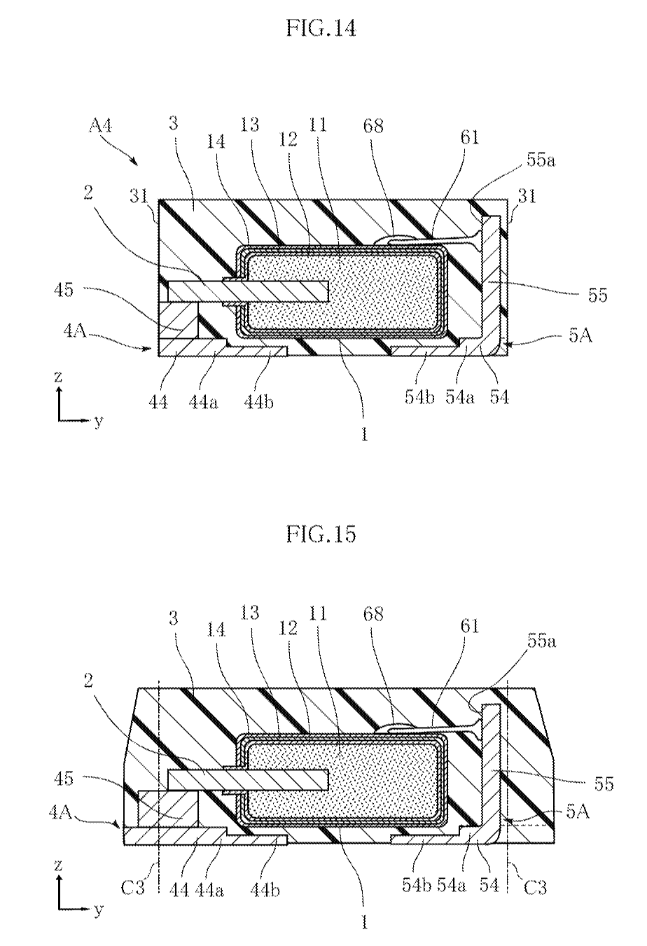

FIG. 14 illustrates a solid electrolytic capacitor according to a fourth embodiment of the present invention. The solid electrolytic capacitor 74 of this embodiment differs from all the foregoing embodiments in that the solid electrolytic capacitor A4 includes end surfaces 31. Specifically, at two ends of the solid electrolytic capacitor A4 which are spaced from each other in the y direction, end surfaces 31 which are parallel with each other are provided. The end surface 31 on the left is made up of part of a surface of the resin package 3 and part of surfaces of the auxiliary portion 45 and thin plate portion 44 of the anode conduction member 4. The end surface 31 on the right is made of part of a surface of the resin package 3.

The thin plate portion 44 includes a thick wall portion 44a and a thin wall portion 44b. To the thick wall portion 44a, the auxiliary portion 45 is bonded. The thick wall portion 44a does not overlap the capacitor element 1 as viewed in the thickness direction of the thin plate portion 44 (as viewed in the z direction). The thickness of the thin wall portion 44h is about half of the thickness of the thick wall portion 44a. The thin wall portion 44b overlaps the capacitor element 1 as viewed in the z direction. That is, at least part of the capacitor element 1 is present right above the thin wall portion 44b.

The thin plate portion 54 includes a thick wall portion 54a and a thin wall portion 54b. The thick wall portion 54a does not overlap the capacitor element 1 as viewed in the z direction. The thickness of the thin wall portion 54b is about half of the thickness of the thick wall portion 54a. The thin wall, portion 54b overlaps the capacitor element 1 as viewed in the z direction.

FIG. 15 illustrates an example of method for making the solid electrolytic capacitor A4. As will be understood from the figure, in this manufacturing method, an intermediate product which is similar to the above-described solid electrolytic capacitor A2 is first prepared. Then, the intermediate product is cut along the cutting lines C3. The cutting line C3 on the left passes through the auxillary portion 45 and the thin plate portion 44.

According to this embodiment, the dimension of the solid electrolytic capacitor A4 in the y direction is further reduced. Moreover, a solder fillet can be formed at the exposed portion of the auxiliary portion 45. The provision of the thin walled portion 44b and 54b allows the capacitor element 1 to be arranged at a relatively low position, which leads to a further reduction in the dimension of the solid electrolytic capacitor A4 in the z direction.

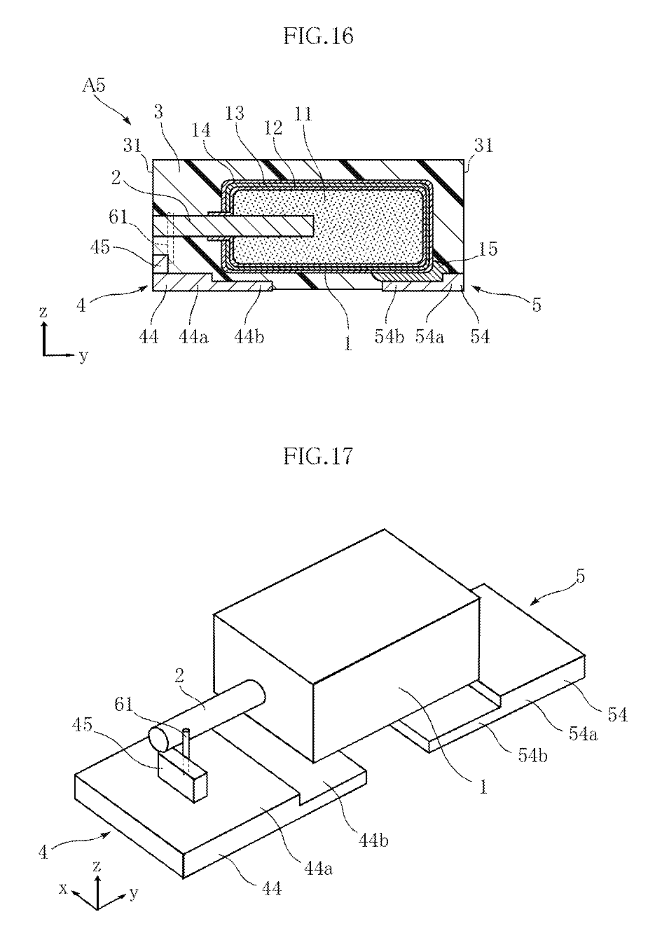

FIGS. 16 and 17 illustrate a solid electrolytic capacitor according to a fifth embodiment of the present invention. The solid electrolytic capacitor A5 of this embodiment differs from the foregoing embodiments in that the fuse wire 61 connects the anode wire 2 and the anode conduction member 4 to each other.

In this embodiment, the fuse wire 61 is bonded to the anode wire 2 and the auxiliary portion 45 by e.g. resistance welding or laser welding. The capacitor element 1 and the cathode conduction member 5 are bonded together with e.g. Ag paste 15. Similarly to the solid electrolytic capacitor A4, the solid electrolytic capacitor A5 has end surfaces 31. In FIG. 17, the illustration of the resin package 3 and the Ag paste 15 is omitted.

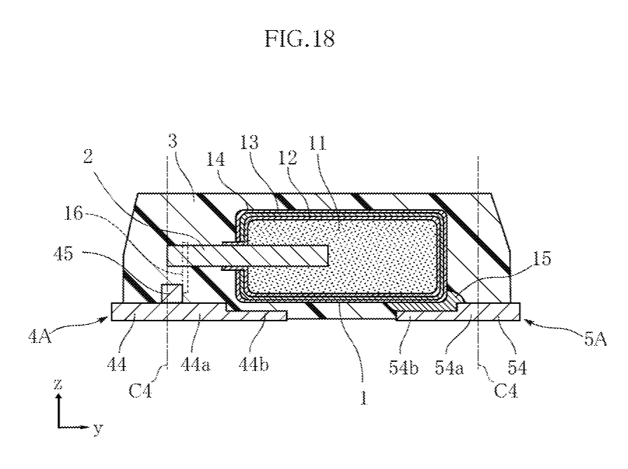

FIG. 18 illustrates an example of method of making the solid electrolytic capacitor A5. As will be understood from the figure, an intermediate product is cut along the cutting lines C4 after the bonding of the fuse wire 61 end the formation of the resin package 3. By this process, the end surfaces 31 as illustrated in FIG. 16 are formed.

According to this embodiment again, the fuse wire 61 properly exhibits the fuse function. By arranging the fuse wire 61 on the anode wire 2 side, an increase in size of the resin package 3 to cover, the fuse wire 61 is avoided. This is favorable for further size reduction of the solid electrolytic capacitor A5.

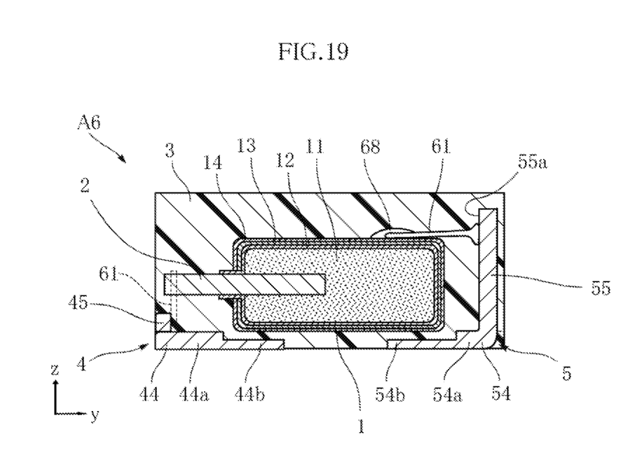

FIG. 19 illustrates a solid electrolytic capacitor according to a sixth embodiment of the present invention. The solid electrolytic capacitor A6 of this embodiment differs from the foregoing embodiments in that the solid electrolytic capacitor A6 includes two fuse wires 61. The fuse wire 61 on the left connects the anode wire 2 and the anode conduction member 4 to each other, whereas the fuse wire 61 on the right connects the conductor layer 14 and the cathode conduction member 5 to each other. An Zn—Al-based alloy may be selected as the material for the fuse wire 61 on the left, whereas an Au—Sn-based alloy may be selected as the material for the fuse wire 61 on ene right. By this selection, the fuse wire E1 on the left functions as an electric current fuse, whereas the fuse wire 61 on the right functions as a temperature fuse.

In particular, since the fuse wire 61 on the right is close to the capacitor element 1, temperature from the capacitor element 1 is easily conducted to this fuse wire. With this feature, when the temperature of the capacitor element 1 unintentionally becomes high, the fuse wire immediately melts and breaks to prevent further temperature increase.

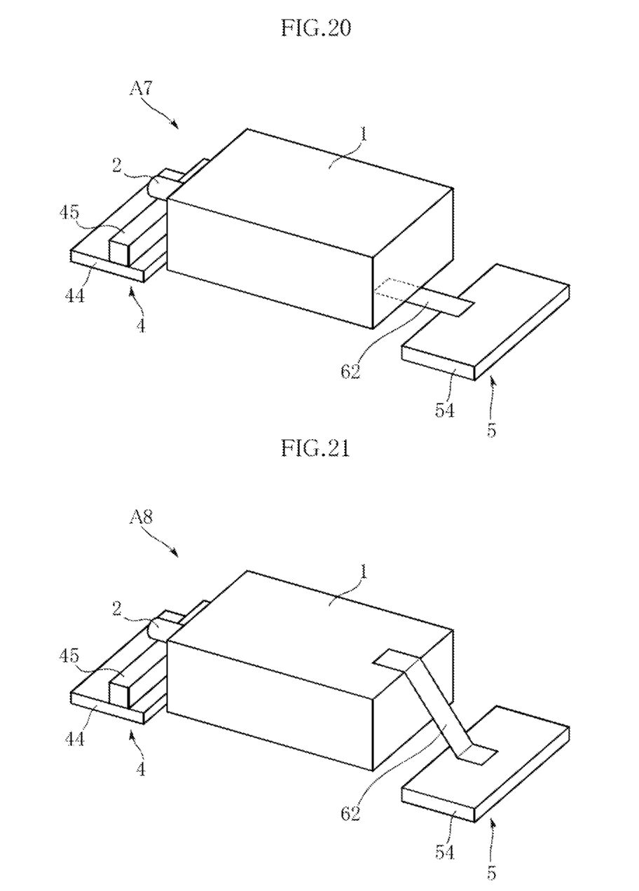

FIG. 20 illustrates a solid electrolytic capacitor according to a seventh embodiment of the present invention. The solid electrolytic capacitor A7 of this embodiment differs from the foregoing embodiments in that the solid electrolytic capacitor A7 includes a fuse ribbon 62 as a conductor to exhibit a fuse function of the present invention. In this figure, the illustration of the resin package 3 is omitted. The fuse ribbon 62 is in the form of a thin strip made of a metal containing at least one of Au—Su-based alloy, Zn—Al-based alloy, Sn—Ag—Cu-based alloy, Sn—Cu—Ni-based alloy and Sn—Sb-based alloy. In this embodiment, the fuse ribbon 62 has a width of about 200 μm and a thickness of about 20 μm. The fuse ribbon 62 connects the capacitor element 1 and the cathode conduction member 5 to each other in this embodiment again, the fuse ribbon 62 properly exhibits a fuse function, while the solid electrolytic capacitor A7 is reduced in size. In particular, the fuse ribbon 62 is suitable for the size reduction of the scud electrolytic capacitor A7 because of its small thickness.

FIG. 21 illustrates a solid electrolytic capacitor according to an eighth embodiment of the present invention. The solid electrolytic capacitor A5 of this embodiment differs from the above-described solid electrolytic capacitor A7 in structure of the fuse ribbon 62. In this embodiment, the fuse ribbon 62 is bonded to the upper surface of the capacitor element 1 and the cathode conduction member 5 and arranged obliquely as a whole. This arrangement makes it possible to make the fuse ribbon 62 longer than that of the solid electrolytic capacitor A7 without changing the arrangement of the capacitor element 1 and the cathode conduction member 5. This is useful for the adjustment of the resistance of the fuse ribbon 62.

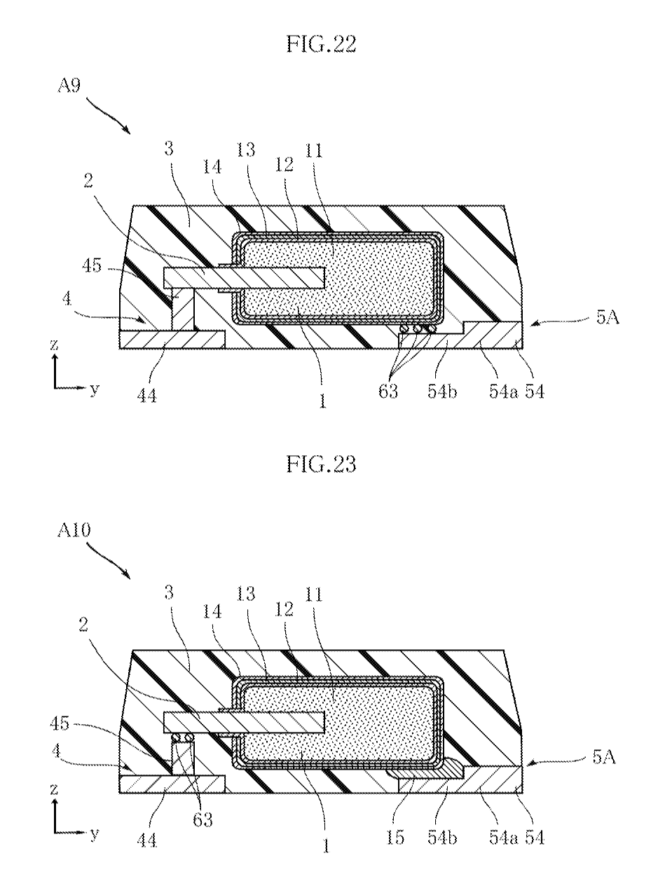

FIG. 22 illustrates a solid electrolytic capacitor according to a ninth embodiment of the present invention. The solid electrolytic capacitor A9 of this embodiment includes fuse beads 63 as a conductor for exhibiting a fuse function of the present invention. The fuse beads 63 are Spherical and made of a metal containing at least one of Au—Su-based alloy, Zn—Al-based Sn—Ag—Cu-based alloy, Sn—Cu—Ni-based alloy and Sn—Sb-based alloy. The fuse beads 63 connect the conductor layer 14 of the capacitor element 1 and The cathode conduction member 5 to each other. This embodiment also provides the solid electrolytic capacitor A9 with a proper fuse function.

FIG. 23 illustrates a solid electrolytic capacitor according to a tenth embodiment of the present invention. The solid electrolytic capacitor A10 of this embodiment differs from the above-described solid electrolytic capacitor A9 in that the fuse beads 63 connect the anode wire 2 and the anode conduction member 4 to each other. This embodiment also provides the solid electrolytic capacitor A10 with a proper fuse function.

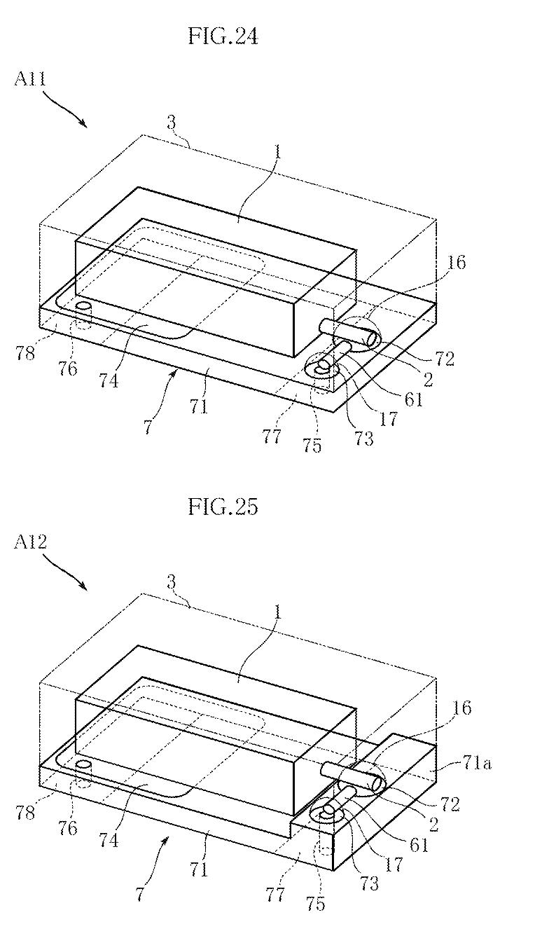

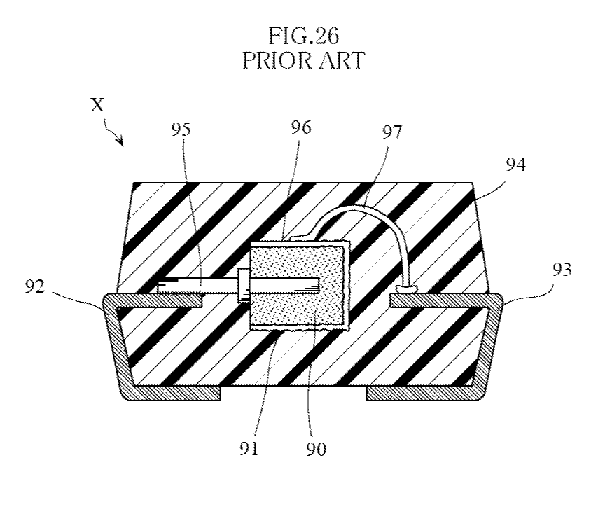

FIG. 24 illustrates a solid electrolytic capacitor according to an eleventh embodiment of the present invention. The solid electrolytic capacitor All of this embodiment differs from all the foregoing embodiments in that the solid electrolytic capacitor All includes a board 7. The board 7 includes an insulating substrate 71, an anode pattern. 72, an intermediate pattern 73, a cathode pattern 74, via holes 75, 76, an anode electrode pattern 77 and a cathode electrode pattern 78. The insulating substrate 71 is made of e.g. an epoxy resin and substantially in the form of a plate. The anode pattern 72, the intermediate pattern 73 and the cathode pattern 74 are formed on the obverse surface of the insulating substrate 71, whereas the anode electrode pattern 77 and the cathode electrode pattern 78 are formed on the reverse surface of the insulating substrate 71. The anode pattern 72, the intermediate pattern 73, the cathode pattern 74, the anode electrode pattern 77 and the cathode electrode pattern 78 are made of e.g. an Au—Ni-plated layer.

The anode pattern 72 is formed adjacent to the center of the insulating substrate 71 in the width direction. The node wire 2 of this embodiment projects horizontally from a lower portion of the capacitor element 1. That is, the anode wire 2 is provided close to the insulating substrate 71 in the thickness direction of the capacitor element 1 (or the thickness direction of the insulating substrate 71). To the anode pattern 72, the anode wire 2 and the fuse wire 61 are bonded with Ag paste 16. To the intermediate pattern 13, the fuse wire 61 is bonded with Ag paste 17. The via hole 73 penetrates the insulating substrate 7 and electrically connects the intermediate pattern 73 and the anode electrode Pattern 77 to each other. The anode electrode pattern 77 is used for the mounting of the solid electrolytic capacitor A11.

The cathode pattern 74 is formed to cover almost half region, in the longitudinal direction, of the obverse surface of the insulating substrate 71. To the cathode pattern 74, the conductor layer 14 of the capacitor element 1 is bonded with Ag paste. The via hole 76 penetrates the insulating substrate 71 and electrically connects the cathode pattern 74 and the cathode electrode pattern 78 to each other. The cathode electrode pattern 78 is used for the mounting of the solid electrolytic capacitor A11.

According to this embodiment, the solid electrolytic capacitor A11 is reduced in size. This embodiment is particularly favorable for the thickness reduction of the solid electrolytic capacitor A11. The fuse wire 61 does not need to be provided by e.g. wire bonding, but can be provided just by arranging, a wire which has a sufficient length to connect the anode pattern 72 and the intermediate pattern 73 to each other. This is suitable for the size reduction of the solid electrolytic capacitor A11.

FIG. 25 illustrates a solid electrolytic capacitor according to a twelfth embodiment of the present invention. The solid electrolytic capacitor A12 of this embodiment differs from the above-described solid electrolytic capacitor A11 in that the insulating substrate 71 of the solid electrolytic capacitor A12 includes a thick wall portion 71a. In this embodiment, the thick wall portion 71a, is provided at a position closer to one end of the insulating substrate 71 in the longitudinal direction. The anode pattern 72 and the intermediate pattern 73 are formed at the thick wall portion 71a. The anode wire 2 projects from the center of the capacitor element 1 in the width direction and the height direction, and the lower end of the anode wire is at the same height as the anode pattern 72 formed at the thick wall portion 71a. With this embodiment again, the solid electrolytic capacitor A12 is reduced in size.

1. A solid electrolytic capacitor comprising:
a capacitor element including a porous sintered body made of valve metal, an anode wire projecting from the porous sintered body, a dielectric layer covering the porous sintered body, and a solid electrolyte layer;
an external conduction member; and
a fuse conductor electrically connecting the external conduction member and one of the anode wire and the solid electrolyte layer to each other;
wherein the fuse conductor is made of a metal containing one of Au—Su-based alloy, Zn—Al-based alloy, Sn—Ag—Cu-based alloy, Sn—Cu—Ni-based alloy and Sn—Sb-based alloy.

2. The sol id electrolytic capacitor according to claim 1, wherein the fuse conductor is a wire having a diameter of 20 to 100 μm.

3. The solid electrolytic capacitor according to claim 2, wherein the fuse conductor includes a bonding portion bonded to one of the anode wire, the solid electrolyte layer and the external conduction member, the bonding portion having a diameter of 200 to 300 μm.

4. The solid electrolytic capacitor according to claim 3, wherein the bonding portion has a height of 30 to 70 μm.

5. The solid electrolytic capacitor according to claim 1, wherein the fuse conductor is made of Au—Sn-based alloy, and weight of Sn lies in one of a range of 5 to 35 and a range of 55 to 75.

6. The solid electrolytic capacitor according to claim 1, further comprising a resin package covering the capacitor element,
wherein the external conduction member includes a thin plate portion, a flat plate portion and a connecting portion, the thin plate portion including a mount terminal portion exposed from the resin package, the flat plate portion being covered with the resin package and bonded to the fuse conductor, the connecting portion connecting the thin plate portion and the flat plate portion to each other.

7. The sol id electrolytic capacitor according to claim 6, wherein the thin plate portion and the flat plate portion are parallel with each other.

8. The solid electrolytic capacitor according to claim 7, wherein the connecting portion is bent and smaller than the flat plate portion in cross section when cut in a plane that is perpendicular to a direction in which the flat plate portion and the thin plate portion are connected to each other.

9. The solid electrolytic capacitor according to claim 8, wherein the connecting portion is covered with the resin package.

10. The solid electrolytic capacitor according to claim 8, wherein part of the connecting portion is exposed from the resin package.

11. The solid electrolytic capacitor according to claim wherein the thin plate portion includes a thin wall portion and a thick wall portion, and as viewed in a thickness direction of the thin plate portion, the thin wall portion overlaps the capacitor element, whereas the thick wall portion does not overlap the capacitor element.

12. The solid electrolytic capacitor according to claim 1, further comprising a resin package covering the capacitor element,
wherein the external conduction member includes a thin plate portion and a standing portion that is perpendicular to the thin plate portion, the thin plate portion including a mount terminal portion exposed from the resin package, the fuse conductor being bonded at an end to the standing portion.

13. The solid electrolytic capacitor according to claim 12, wherein the thin plate portion includes a thin wall portion and a thick wall portion, and as viewed in a thickness direction of the thin plate portion, the thin wall portion overlaps the capacitor element, whereas the thick wall portion does not overlap the capacitor element.

14. The solid electrolytic capacitor according to claim 1, further comprising a resin package covering the capacitor element,
wherein: the external conduction member is electrically connected to the anode wire; part of a surface of the external conduction member and part of a surface of the resin package are connected to be flush with each other to form an end surface; and the anode wire extends in a direction crossing the end surface.

15. The solid electrolytic capacitor according to claim 14, wherein the anode wire and the external conduction member are electrically connected to each other by the fuse conductor.

16. The solid electrolytic capacitor according to claim 14, wherein the external conduction member includes a thin plate portion including a mount terminal portion exposed from the resin package, the thin plate portion includes a thin wall portion and a thick wall portion, and as viewed in a thickness direction of the thin plate portion, the thin wall portion overlaps the capacitor element, whereas the thick wall portico does not overlap the capacitor element.

17. The solid electrolytic capacitor according to claim 1, wherein the fuse conductor has a strip-like form.

18. The solid electrolytic capacitor according to claim 1, wherein the fuse conductor is spherical.

19. The solid electrolytic capacitor according to claim 1, wherein the porous sintered body is made of one of tantalum and niobium.

20. A solid electrolytic capacitor comprising:
a capacitor element including a porous sintered body made of valve metal, an anode wire projecting from the porous sintered body, and a dielectric layer and a solid electrolyte layer covering the porous sintered body;
an external conduction member;
a fuse conductor electrically connecting the external conduction member and one of the anode wire and the solid electrolyte layer to each other; and
a board that includes: a plate-like insulating substrate; an anode pattern and an intermediate pattern both formed on an obverse surface of the insulating substrate, the intermediate pattern being spaced away from the anode pattern; an anode electrode pattern formed on a reverse surface of the insulating substrate; and an anode via hole connecting the intermediate pattern and the anode electrode pattern to each other;
wherein the anode wire is hooded to the anode pattern, and the anode pattern and the intermediate pattern are connected to each other by the fuse conductor.

21. The solid electrolytic capacitor according to claim 20, wherein the anode wire is arranged adjacent to the insulating substrate in a thickness direction of the capacitor element.

22. The solid electrolytic capacitor according to claim 20, wherein the board is provided with: a cathode pattern formed on the obverse surface of the insulating substrate; a cathode electrode pattern formed on the reverse surface of the insulating substrate; and a cathode via hole connecting the cathode pattern and the cathode electrode pattern to each other, the cathode pattern being electrically connected to the solid electrolyte layer.

23. The solid electrolytic capacitor according to claim 20, wherein the fuse conductor is made of a metal containing one of Au—Su-based alloy, Zn—Al-based alloy, Sn—Ag—Cu-based alloy, Sn—Cu—Ni-based alloy and Sn—Sb-based alloy.

24. The solid electrolytic capacitor according to claim 20, wherein the porous sintered body is made of one of tantalum and niobium.

25. A method of making a solid electrolytic capacitor including a capacitor element including a porous sintered body made of valve metal, an anode wire project Log from the porous sintered body, and a dielectric layer and a solid electrolyte layer covering the porous sintered body, the method comprising the steps of:
bonding a first end of a fuse conductor to an external conduction member by ball bonding; and
electrically connecting a second end of the fuse conductor to one of the anode wire and the solid electrolyte layer.

26. The method according to claim 25, further comprising the steps of:
making the fuse conductor stand after bonding the first end of the fuse conductor to the external conduction member;
bending the external conduction member, with the fuse conductor bonded thereto; and
bonding the second end of the fuse conductor to the conductor layer, with the external conduction member bent.

27. The method according to claim 25, wherein the fuse conductor is made of a metal containing one of Au—Su-based Zn—Al-based alloy, Sn—Ag—Cu-cased alloy, Sn—Cu—Ni-based alloy and Sn—Sb-based alloy.

28. A method of making a solid electrolytic capacitor including a capacitor element including a porous sintered body made of valve metal, an anode wire projecting from the porous sintered body, and a dielectric layer and a solid electrolyte layer covering the porous sintered body, the method comprising the steps of:
bonding a first end of a fuse conductor to an external conduction member;
electrically connecting a second end of the fuse conductor to one of the anode wire and the solid electrolyte layer;
forming a resin package to cover the capacitor element; and
collectively cutting the resin package and the external conduction member.

29. The method according to claim 28, wherein the fuse conductor is made of a metal containing one of Au—Su-based Zn—Al-based alloy, Sn—Ag—Cu-based alloy, Sn—Cu—Ni-based alloy and Sn—Sb-based alloy.
